(19) United States
(12) Patent Application Publication
(10) Pub. No.: US 2023/0034287 A1
(43) Pub. Date: Feb. 2, 2023

(54) Robot that Concurrently Learns Recognition and Synthesis while Developing a Motor

(71) Applicants: Juyang Weng, Okemos, MI (US); Xiang Wu, Nanjing (CN)

(72) Inventors: Juyang Weng, Okemos, MI (US); Xiang Wu, Nanjing (CN)

(21) Appl. No.: 17/379,344

(22) Filed: Jul. 19, 2021

(51) Int. Cl. G06N 3/00; G06N 3/04; G06N 3/08

(52) U.S. Cl. CPC G06N 3/008; G06N 3/04; G06N 3/08

(57) ABSTRACT

Traditionally, learning speech synthesis and speech recognition were investigated as two separate tasks. This separation hinders incremental development for concurrent synthesis and recognition, where partially-learned synthesis and partially-learned recognition must help each other throughout lifelong learning. This invention is a paradigm shift—we treat synthesis and recognition as two intertwined aspects of a lifelong learning robot. Furthermore, in contrast to existing recognition or synthesis systems, babies do not need their mothers to directly supervise their vocal tracts at every moment during the learning. We argue that self-generated non-symbolic states/actions at fine-grained time level help such a learner as necessary temporal contexts. Here, we approach a new and challenging problem—how to enable an autonomous learning system to develop an artificial motor for generating temporally-dense (e.g., frame-wise) actions on the fly without human handcrafting a set of symbolic states. Here the artificial motor corresponds to a combination of a multiplicity of robotic effectors, including, but not limited to, speaking, singing, dancing, riding a bike, swimming, and driving a car. The self-generated states/actions are Muscles-like, High-dimensional, Temporally-dense and Globally-smooth (MHTG), so that these states/actions are directly attended for concurrent synthesis and recognition for each time frame. Human teachers are relieved from supervising learner's motor ends. The Candid Covariance-free Incremental (CCI) Principal Component Analysis (PCA) is applied to develop such an artificial speaking motor where PCA features drive the motor. Since each life must develop normally, each Developmental Network-2 (DN-2) reaches the same network (maximum likelihood, ML) regardless of randomly initialized weights, where ML is not just for a function approximator but rather an emergent Turing Machine. The machine-synthesized sounds are evaluated by both the neural network and humans with recognition experiments. Our experimental results showed learning-to-synthesize and learning-to-recognize-through-synthesis for phonemes. This invention corresponds to a key step toward our goal to close a great gap toward fully autonomous machine learning directly from the physical world.

### BACKGROUND OF THE INVENTION

Let us consider a new kind of robot that develops a motor while it concurrently learns recognition and acting on the fly. Here the robot motor corresponds to a combination of a multiplicity of robotic effectors, including, but not limited to, speaking, singing, dancing, riding a bike, swimming, and driving a car. In this invention, we use a speaking motor as an example for the motor. The speaking motor directly drives a loud speaker. The effects of the motor are sensed by any sensors, such as vision, audition, touch, taste, and smell. In this invention, we use a microphone as an example for the sensor. The same robotic algorithm in this invention is applicable to any motor modality and any sensory modality.

Traditionally, robot speaking (e.g., speech synthesis) and robot hearing (e.g., speech recognition) are trained separately, not concurrently. In a process called symbolic annotation, a human expert handcrafts a static set of symbolic classes and annotates sound signals using the classes. Consequently, robot learning is not fully autonomous, unlike a human child. We believe that such human symbolic annotations are a fundamental reason that trained robots are brittle in real world—they cannot learn new skills beyond the annotations. This invention is annotation-free.

Many research efforts in robotic learning have been fruitfully inspired by studies of human learning. However, they require symbolic labels. Unsupervised learning, e.g., k-mean clustering, gives unsupervised symbolic labels; reinforcement-learning methods, e.g., Q-learning, use symbolic labels as states. Although they aim at providing a general learning framework, many methods do not perform autonomous development. Their computational frameworks (including rigid symbolic nodes and boundaries) are handcrafted based on the human designer's understanding of a given robotic task at hand. In contrast, the autonomous development paradigm [29] requires that the Developmental Program (DP) (like functions of the genome) is decided before given any specific tasks so that incremental learning takes place across an open-ended array of tasks. The skills learned during early simpler tasks can assist the learning of later more complicated tasks, which is consistent with the scaffolding way in developmental psychology [34]. FIG. 1 shows some key differences between these two paradigms. In the manual development paradigm, the human needs to design or adjust the robot's program before every specific robotic task. In the autonomous development paradigm, the human only designs the robot's DP before any tasks are known. Then the DP incrementally updates during the robot's learning procedure.

As summarized in Weng 2012 [30], there are five essential factors that determine the capability of an robot in the autonomous development paradigm: (i) the sensors; (ii) the effectors; (iii) the computational resources; (iv) the DP (like the function of genes) and (v) how the robot is taught (i.e., its environment). Our biologically plausible model Developmental Network 1 (DN-1) is from the autonomous development paradigm [29], [30]. However, at each discrete time from inception t=0, 1, 2, . . . , each DN-1 as a life from DP is optimal at each time t in the sense of maximum likelihood as mathematically proven using mathematical induction [31], conditioned on the Three Learning Conditions (3LC): (1) framework restrictions (e.g., incremental learning), (2) learning experience, and (3) the limited computational resources.

Table I compares the major differences between the traditional paradigm and the reported new advances from the developmental paradigm that was first proposed in Weng et al. 2001 [29]. This invention focuses on (ii) effectors (i.e., motor development) and (v) the way to teach the learning robot. In particular, we study (1) how to develop motor states for synthesis in a self-supervised way and (2) how to generate frame-wise action sequences through recognition of context in every time frame. The motor states not only drive the motor to directly generate action frames to the environment but also provide context information to facilitate the development of the learning system's context—which dependent recognition and behaviors. The actions focused on here are fine-grained time level ones, is different from the motor development studies for macro motions [17]. The developed learning system learns and updates discretely, the sensory input of raw sound sequences is decomposed into sound frames (e.g., 20 ms length). The frame-wise actions also output at discrete time steps to form the continuous behavior.

To learn from natural sounds so that the learning system can synthesize, we require to develop a space

TABLE I
Comparison between traditional machine learning
paradigms and the new developmental paradigm

| | | New developmental |
|---|---|---|
| Categories | Traditional paradigm | paradigm |
| Task | Task-specific (TS) | Task-nonspecific |
| Motor | Handcrafted symbolic | CCI PCA basis, |
| | labels | nonsymbolic |
| No. of classes | Handcrafted and static | Unknown and dynamic |
| Initial states | Symbolic, k-mean | Clustering-free PCA |
| | clustering | vectors |
| Train vs. test | Two separate stages | Concurrent, in a single |
| | | life |
| Speak/listen | Not both concurrently | Both concurrently |
| Convolution | Hand-imposed | Convolution-free |
| Skull | Skull-open | Skull-closed (hidden |
| | | area) |
| Prosody | Limited, rigid, | Free, dynamic, |
| | handcrafted | autonomous |
| Train | Supervised or | Self-supervised by |
| | reinforcement | listening |
| Batch | Mostly batch learning | Incremental learning |
| Synthesis test | Driven from given | Autonomous judged by |
| | symbols | humans |
| Recog. test | Misclassification as | via synthesis judged by |
| | symbols | humans |
| To understand | Easier | Harder |
| Cost to model | Labor-intensive | Labor-light |
| Creativity | Limited by TS and 3LC | Limited by 3LC |

of frame-wise motor states that are Muscles-like, High-dimensional, Temporally-dense, Globally-smooth (MHTG). By “muscles-like”, we would like to incrementally develop a motor state space of a reduced dimension that is sufficient to generate all needed actions, like human muscles. By “high-dimensional”, we mean that both the original and synthesized frames of sound are in a space of high dimension. By “temporally-dense”, we mean that the networks must generate a motor state vector every 20 ms, too temporally-dense for a human to supervise. By “globally-smooth”, we hope that the manifolds of motor states for synthesizing sounds are smooth, so that neural networks can perform interpolations in such a feature space. The Emergent Turing Machine (ETM) [31] seems to be a feasible framework to develop such a learning system with MHTG features. ETM is in the autonomous development paradigm, and can be considered as a Turing Machine with emergent representations. We will explain the details in section I-A.

Next, let us discuss some key background concepts as the introductory background so that the invention is self-contained.

### A. Background: From Symbolic to Emergent Representations

When learning through interaction with the environment, the robot acts not only according to the current sensory inputs but also the recent dynamic history of the robot and the environment. By recent dynamic history, we mean the spatiotemporal contexts contained in the states or actions. In this invention, state and action refer to the same MHTG vectors. So they are interchangeably equivalent, unless explicitly stated otherwise.

In recent years, many methods have been proposed for dealing with spatiotemporal contexts. Hidden Markov Models (HMMs) based methods design symbolic states to correspond to different clusters of sensory data or context features. These methods often use probabilities to alleviate inconsistency between state transitions [2]. HMMs are often cascaded to construct layered probabilistic representations for the data with a hierarchical structure [21]. Dynamic Bayesian Networks (DBNs), also symbolic, can explicitly represent the causal relation across time series [20], [22]. The above computational models deal with high-level discrete concepts since their symbolic representations are carefully and statically handcrafted based on a static data set and a given task.

Many neural networks use emergent representations, at least partially. The Recurrent neural networks (RNNs) are meant to deal with sequences since they include the connections along temporal trajectories [23], [19]. Recently, Long Short-Term Memory (LSTM) RNNs increased popularity in experimental studies for temporal problems as they detect latent temporal dependencies [8], [16]. These methods are meant for classification of sensory data since their emergent representations are extracted directly from the sensory domain.

The emergent representation is also used in our invention. Compared with the symbolic representation, the emergent representation is natural and open-ended. By natural, we mean that the sensory and motor vectors are developed from raw and natural sensors (e.g., microphones) and effectors (e.g., speakers). Emergent patterns from the same sources have distances in the neuronal feature spaces. The similarities of these patterns are easier to measure according to the distances between them. So the rich relations among raw sensory data or motor data are kept. By open-ended, we mean that with emergent representations, new categories can be naturally processed according to their distances with observed categories. This is suitable for open-ended autonomous development because humans are not needed in the loop of handcrafting for new categories. In summary, clusters that arise from such unsupervised clustering do not need to be defined by the user and the model finds them dynamically based on the observations. Both the complexity and the number of such clusters are too high to be humanly tractable, as one can imagine from FIG. 9. (a) The color corresponds to the phoneme type concept. (b) the color corresponds to the MHTG actions.

### B. Background: Autonomous Development Paradigms

The traditional methods do not directly take state patterns from the motor ends as contexts, which means they are not open-ended. A learning framework following the autonomous development paradigm [29] is needed to handle an open-ended set of frame-wise states. The frame-wise incremental learning mode in this framework is helpful because the next sensory frame processing can depend on the current state/action—sensorimotor recursive—and learning may take place on the fly.

As an example from the autonomous development paradigm, DN-1 incrementally develops through its grounded learning experience in the physical world by extracting emergent patterns from a lifelong sequence of inputs and outputs. Different from many other neural networks which act like a “black box”, DN-1 learns an ETM with clear logics and statistical optimality. DN-1 has been successfully experimented with different modalities (e.g., vision [38], audition [36], and text [3]). Although DN-1 has been tested with multiple hidden areas, there are two restrictions. (A) The boundary of each area and neuronal resources in each area are fixed. (B) There are no excitatory connections among neurons in the same hidden area.

To address these restrictions, DN-2 [37] was proposed based on DN-1 by adding several new mechanisms. Each neuron in DN-2 can automatically develop its excitatory connections and its own inhibition zone. So the number of areas and the neurons' connection relations are automatically determined by the learning experience instead of being pre-handcrafted. Namely, a DN-2 can automatically generate hierarchical inner representations to abstract concrete examples. And the ETM logic enable DN-2 to directly take context patterns from the motor ends as self-supervisions so that learning can take place even without outside supervision.

Our past work has shown that frame-wise states/actions (e.g., stages within a phoneme) are useful to generate temporally-sparse label (the type of the phoneme). However, such frame-wise states are learned from dense handcrafted labels. These handcrafted frame-wise states are not suited for forming continuous behaviors in real-time (e.g., producing a sound from a speaker). Therefore, we need to design automatically developmental motors so as to totally get rid of handcrafted labels.

### C. Background: Developing Motor Representations Without Handcrafting Labels

In the real world, the raw sequential data is easy to acquire but the labeling work is costly, slow and in batch. Therefore, there has been an increasing interest in unsupervised and self-supervised learning modes. One popular method in unsupervised fashion is using auto-encoder architectures [26], [7]. Based on reconstructing data at the output end, the encoders in these architectures are well trained for extracting sufficient features from inputs. Self-supervised learning methods often create self-supervised objectives to train the model [6].

For the autonomous development paradigm here, it is intractable for a human designer to label all the states or actions for each situation the learning robot may meet. In this invention, we investigate how the DN-2 directly generates meaningful states as actions for every time frame to form the natural continuous behaviors only with self-supervision. We also analyze how these emergent frame-wise actions can liberate humans from the tedious labeling work and help the model to emerge some high-level concepts with very sparse supervision at the effector ends. Instead of handcrafting a physical model of human vocal tract (e.g., [1]), Candid Covariance-free Incremental (CCI) Principal Component Analysis (PCA) [33] is used in our experiments to generate the lower-dimensional and reconstructable motor states. Furthermore, the real value sections are designed in the motor area of DN-2 to easily perceive these motor states and merge frame-wise motor actions. So DN-2 can quickly reach optimal performance in the sense of maximum likelihood with limited training samples. This is different from the speech synthesis and recognition systems based on deep neural networks (e.g., [25], [15]), who often require a large number of samples and many iterations of training to achieve good results. The frame-wise actions can form both declarative skills and non-declarative skills (details in Appendix).

This invention includes a conference publication at International Joint Conference on Neural Networks (IJCNN) [35] that is within a year from the nonprovisional filing of this invention dated Jul. 19, 2021. The provisional filing dated May 5, 2021 of this invention extended [35] with additional new ideas:
1) We use the learn-to-recognize-through-synthesis procedure to replace the original simple synthesis learning. The synthesis and recognition are treated as two intertwined aspects of the learning robot. This procedure can demonstrate that emergent frame-wise motor actions can help DN-2 to generate high-level concepts with temporally-sparse supervision.
2) Instead of PCA, we applied CCI PCA to develop the frame-wise states of the speaking motor. CCI PCA does not need to compute the covariance matrix of all inputs. It can incrementally compute PCA vectors using sequentially arriving inputs, which is suitable for DN-2′s incremental learning way.
3) The properties of CCI PCA motor states are further summarized. Namely, these frame-wise states are MHTG without any offline processing, and they can enable the fully autonomous synthesis of DN-2 without a human in the loop.
4) More comparison experiments are conducted to analyze the effects of emergent frame-wise motor actions. Evaluation of synthesis by human subjects is also included for perfect analysis.

### BRIEF SUMMARY OF THE INVENTION

Traditionally, learning speech synthesis and speech recognition were investigated as two separate tasks. This separation hinders incremental development for concurrent synthesis and recognition, where partially-learned synthesis and partially-learned recognition must help each other throughout lifelong learning. This invention is a paradigm shift—we treat synthesis and recognition as two intertwined aspects of a lifelong learning robot. Furthermore, in contrast to existing recognition or synthesis systems, babies do not need their mothers to directly supervise their vocal tracts at every moment during the learning. We argue that self-generated non-symbolic states/actions at fine-grained time level help such a learner as necessary temporal contexts. Here, we approach a new and challenging problem—how to enable an autonomous learning system to develop an artificial speaking motor for generating temporally-dense (e.g., frame-wise) actions on the fly without human handcrafting a set of symbolic states. The self-generated states/actions are Muscles-like, High-dimensional, Temporally-dense and Globally-smooth (MHTG), so that these states/actions are directly attended for concurrent synthesis and recognition for each time frame. Human teachers are relieved from supervising learner's motor ends. The Candid Covariance-free Incremental (CCI) Principal Component Analysis (PCA) is applied to develop such an artificial speaking motor where PCA features drive the motor. Since each life must develop normally, each Developmental Network-2 (DN-2) reaches the same network (maximum likelihood, ML) regardless of randomly initialized weights, where ML is not just for a function approximator but rather an emergent Turing Machine. The machine-synthesized sounds are evaluated by both the neural network and humans with recognition experiments. Our experimental results showed learning-to-synthesize and learning-to-recognize-through-synthesis for phonemes. This invention corresponds to a key step toward our goal to close a great gap toward fully autonomous machine learning directly from the physical world.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a comparison between (a) the manual development paradigm and (b) the autonomous development paradigm.

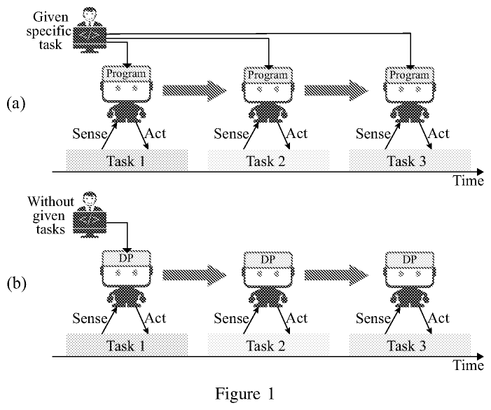

FIG. 2 is a DN-2 that interacts with the physical environment in real-time to learn the synthesis and recognition of natural sounds.

FIG. 3 is the learning procedure of DN-2 across time series is shown. In the Y area, we just illustrate types of Y neurons grown in our experiments.

FIG. 4 is an illustration about dimension reduction.

FIG. 5 is a comparison between original and synthesized waveforms for phoneme [symbol] .

FIG. 6 is a comparison between original and synthesized waveforms for short vowel /Λ/, long vowel [symbol] , gliding vowel [symbol] and consonant /l/ respectively.

FIG. 7 is an illustration about simultaneous phoneme recognition and synthesis using lateral connections for spatial attention and temporal warping.

FIG. 8 is an illustration about what hidden neurons of type 111 detect.

FIG. 9 is an illustration about embedding of type 111 hidden neurons and motor neurons to be contained into a brain-shape contour.

FIG. 10 is an illustration about confusion matrix of 20 self-synthesized phonemes by 15 human 21 subjects.

### DETAILED DESCRIPTION OF THE INVENTION

### I. New Framework For Listening and Speaking at the Same Time

A human mother does not need to supervise her baby's vocal tract because the genes have enough information to guide the development of a human vocal tract. Our artificial vocal tract has an artificial “genes” program that corresponds to CCI PCA which develops PCA features directly from sound waves it heard. Such PCA features are used by the motor area to synthesize sounds. In other words, our approach uses the environmental sounds to develop a virtual vocal tract. The environmental sounds that supervise the motor area can be either from the human teacher or the machine learner's own sounds. Because the DN (both DN-1 and DN-2) can produce MHTG action frames to synthesize sounds even when there is no supervision from the teacher.

To generate MHTG actions, we need a powerful computational model called Turing machines [18].

A traditional paradigm for neural networks for pattern recognition is as follows: Construct a neural network \hat{ƒ} that approximates an unknown function ƒ: X [symbol] Z, that maps from domain X to co-domain Z. The domain X contains many (practically infinite) sensory input samples, where each sample can be a video snapshot or a feature vector of 20 ms sound. Z contains a static set of symbols, representing pre-assigned class label of each sample in X. Such a set Z represents a pre-given task.

The autonomous developmental paradigm [29] has gone beyond this paradigm, now well known as task-nonspecificity following animal development. Namely, at least Z is not given at any time t₀ during living of a life, the environment (e.g., teachers and parents) does not know what concepts need to be learned in later lifetime t>t₀. For example, the learner may invent something that all parents do not predict well or feel too tedious to predict for their children. Thus, any static symbolic set Z might be undesirable, not just insufficient for t>t₀, but also detrimental to t 23 t₀. In other words, t>t₀ and t≤t₀ should follow the same developmental paradigm so that at any time t in a life, any symbolic set Z is not desirable.

In this invention, we assume that Z consists of muscle neurons that can produce any sounds. The meanings of the frames in Z are not statically assigned with symbolic labels, so that learning can be fully autonomous, because any symbols require a human (teacher or parent) in the loop of handcrafting and consequently hinders fully autonomous learning and discovery. In particular, X and Z are all indents in time as (X(t), Z(t)), where t=0 means the time for life inception and Z(t+1) depends on (X(t), Z(t)) in the simplest form for understanding because Z(t) can contain necessary previous temporal contexts as a state in a Turing machine.

### A. From Symbolic Turing Machines To Emergent Turing Machines

To facilitate understanding, let us start with symbols. Assume a human's knowledge base is representable by a grand Turing Machine (TM). Weng2015 [31] has proven that the control of any ™ is an agent Finite Automaton (FA).

Suppose that the FA control has alphabet Σ={σ₁, σ₂, . . . , σₙ}, a set of states Q={q₁, q₂, . . . , qₘ}, and a static lookup table as its transition function δ: Q×Σ→Q. The lookup table has n columns for n input symbols and m rows for m states. Each transition is from state qᵢ and input σⱼ , to the next state qₖ, denoted as (qᵢ, σⱼ)→qₖ, corresponding to the qₖ entry stored at row i and column j in the lookup table.

Let n grounded (emergent) vectors X={x₁, x₂, . . . , xₙ} represent the n (static) symbols in Σ, so that xⱼ≡σⱼ, j=1, 2 , . . . , n where ≡ means “corresponds to”. Likewise, let m (emergent) vectors Z ={z₁, z₂, . . . , zₘ} represent the m (static) symbols in Q, so that zᵢ≡qᵢ, ⁱ=1, 2, . . . , m. Thus, each symbolic transition (left, static) in FA corresponds to the vector mapping (right, emergent) in the DN:

[(qᵢ,σⱼ)→qₖ]≡[(zᵢ, xⱼ)→zₖ] (1)

The lookup table for the human common-sense base is exponentially wide and exponentially high, but also extremely sparse. Yet, the right-hand side in the above equation only uses observed sparse entries emerged, where each entry corresponds to a neuron in the DN that learns the FA in vector forms in Eq. (1).

In FA, we use q and σ both to predict σ′:

$$[ \begin{matrix}q \\ σ\end{matrix} ] \to [ \begin{matrix}{q}^{′} \\ {σ}^{′}\end{matrix} ] . \qquad ( 2 )$$

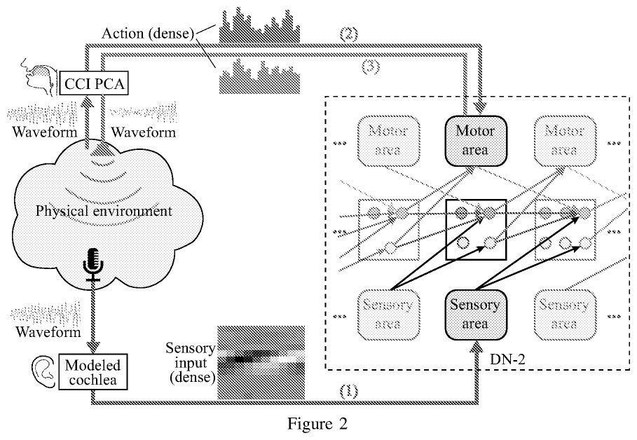

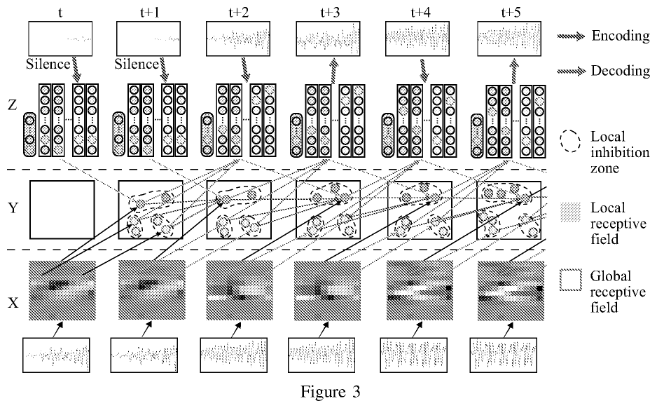

In emergent vector form inside DN, we use hidden Y area to take input from (z, x) to produce a response vector y which is then used by Z and X areas to predict z and x respectively:

$$[ \begin{matrix}z \\ x\end{matrix} ] \to y \to [ \begin{matrix}{z}^{′} \\ {x}^{′}\end{matrix} ] \qquad ( 3 )$$

where the→denotes the update on the right side using the left side as input. Like the FA, each prediction in Eq. (3) is called a transition. The quality of prediction depends on how state/action z abstracts the external world sensed by x′. The learning procedure of DN-2 shown in FIGS. 2 and 3 can assist readers to approximate the transition in Eq. (3). For example, the Chapter 7 (spatial processing) and Chapter (temporal processing) of Weng [30] explained, respectively, how the state/action represented by the z sequence in Eq. (3) can be taught to conduct any practical spatial and temporal processing for the sensory sequences represented by x, such as any spatial attention and temporal attention, including cuts, flushes, links, and combinations thereof etc.

In FIG. 2, we show the procedure that DN-2 learns to synthesize and recognize natural sounds through the interaction with the environment. Specifically, auditory sequences are processed and fed to a DN-2 frame by frame (flow (1) in FIG. 2) as well as the corresponding frame-wise actions encoded by CCI PCA (flow (2) in FIG. 2). After learning, DN-2 can generate frame-wise actions and decode them as i sound sequences (flow (3) in FIG. 2). With the contexts provided by these frame-wise actions, DN-2 can learn the recognition of the sounds with only temporally-sparse supervision. In our experiments, the streams are from 20 English phonemes. Each frame spans 20 ms long. During learning, the DN-2 dynamically clusters the sensorimotor inputs in the hidden area whose responses are sent to the motor area to generate the frame-wise actions.

### B. Input Sequences as Equivalent Classes

Consider the input space of DN to be X=R^{l}, where R is the set of real numbers and X consists of real-valued vectors of dimension l. Consider the motor space of DN to be Z=Rⁿ, where Z consists of real-valued vectors of dimension n. For example, l=n=882 for each frame in our experiments: The learner hears sound and pronounces sound. The neurons in hidden area Y form the “brain” of DN.

According to the DN theory [31], a DN learns an Emergent Turing Machine, where the motor area Z corresponds to the set of state vectors of the FA controller of the Turing Machine; X corresponds to the set of input vectors of the FA. The number of neurons in DN corresponds to the total number of entries of the huge but sparse transition table of FA that has been observed and learned. Because the number m of (hidden) Y neurons in DN is finite, what does the DN do for the inputs in X and the states/outputs in Z? We use a well-known property of FA to reach the following new theorem.

Theorem 1 (DN equivalent classes): Suppose X and Z are represented by finite resolution real-valued vectors as in digital computers. The DN with a finite number of neurons groups all input sequences in X into a finite number of equivalent classes, meaning that all sequences from X produce exactly the same output vector in motor space Z. Further, there is a minimum-state DN that has the fewest states among all functionally equivalent DNs. This minimum-state DN corresponds to the most-coarse partition of all possible input sequences accumulated from frames in the sensory space X.

Proof: Note, although the length of each sequence (e.g., reading a book as a sound sequence) is unbounded, each sequence read by the DN is finite. According to the proof of Theorem 1 in [31],using inner product distance metrics in real-valued joint space (X, Z), DN partitions the real-valued sequences from frames in X into a large number of equivalent classes per automata theory [18]. All vector sequences (not individual vectors in X) that belong to the same equivalent class generate the same output vector in Z since Z has a finite resolution in digital computers, therefore, Z contains only a finite number of states. E.g., many phonemes and words sound different but they are equivalent. The minimum-state DN is equivalent to the corresponding minimum-state FA.

Each sequence in X is like a spatiotemporal experience from the time the robot opens his eye in the morning of a day. Two sequences x₁ and x₂ belong to the same equivalent class means that x₁ and x₂ result in the same state/action z∈Z. A non-minimum DN is like a colleague who requires a larger brain or consumes more hidden neurons to reach the same behavior performance as the minimum-state DN. Obviously, whether a DN is a minimum-state DN depends on all five essential factors discussed in Background of The Invention.

### C. Action-Vector Encoding Through CCI PCA

As we stated in [36], taking self-synthesized actions as contexts can help the robot to automatically generate temporally-dense actions. In our previous phoneme recognition experiments, these temporally-dense actions can provide more context information as temporally-dense labels to support the state transfers of DN-1. In this condition, DN-1 is easier to complete the recognition task (only with phoneme type labels at the end of the sequence). But these actions are learned from handcrafted labels. They do not have meanings other than those pronounced by directly driving a speaker to speak.

Let us consider how to enable a DN to generate continuous actions (e.g., learn to speak by listening). We consider how the DN learns to produce sound waves while it practices repeating what it hears like a baby.

For temporally-dense contexts, a new method is needed for generating MHTG vectors as actions without using dense handcrafted labels. We need to map the sound waves to a lower-dimensional space to obtain lower-dimensional patterns so that the number of Z neurons is moderate (e.g., k=60). We did not take raw sensory inputs as supervised patterns directly because some trivial details of the raw sound waves are unnecessary to include. We need a feature space that is optimal to re-construct sound waves so that the sounds produced are natural and recognizable.

In this invention, the CCI PCA [33] is used to replace traditional PCA [11], [13] to reduce the dimension of the raw inputs. CCI PCA is an incremental method to compute PCA vectors directly from sequentially arriving raw vectors without computing the covariance matrix at all, which is suitable for our incremental learning method DN and our required real-time online self-supervision. The CCI PCA algorithm is attached in the Appendix. The projection matrix W can be considered as an automatically developed model for the “verbal tract”. Some characteristics of encoding raw sound frames as motor actions are listed in [35].

When encoding sound inputs as frame-wise actions, continuous actions emerge to form a natural behavior. Then short behaviors chain together to constitute a meaningful skill. This is how humans acquired language in early years [5]: Babies always start with babbling. Then, they learn to combine random sounds to produce phonemes. Gradually they learn words from phonemes and sentences from words. The work in [12] studied the robot's verbal learning of speech production using a “follow me” paradigm by integrating the high dimensional action and context space.

Let us take the learn-to-recognize-through-synthesis procedure of DN-2 as an example (shown in FIG. 2). The interactions are through three flows marked as (1), (2) and (3). The environment directly provides frame-wise sensory inputs. These inputs are processed by the modeled cochlea, then fed to the sensory area of DN-2 through flow (1). In the meantime, the motor area of DN-2 connects with the environment in two directions through a constantly developing motor (CCI PCA). Regardless of whether the learner speaks or others in the environment, DN-2 hears from its cochlea. Through flow (2), the sensory inputs are encoded by CCI PCA as frame-wise actions to self-supervise DN-2. Through flow (3), the frame-wise actions generated by DN-2 are decoded by CCI PCA to form the sound sequence to the environment.

The DN-2 learns to synthesize the phonemes based on the sensory inputs and corresponding self-supervised PCA contexts provided by the frame-wise actions. Near the end of the sound, the sparse label of phoneme types can be offered to the DN-2 to link its pronunciation with the phoneme class concept. In this case, the frame-wise actions enable DN-2 to successfully form natural continuous behaviors. As intermediate states, these fine-grained level synthesized actions can also assist DN-2 to learn the abstract high-level concept only with temporally-sparse supervision.

D. MHTG Properties

Temporally-dense labels that we have used before in [36] require a batch k-mean clustering process to group similar labels into a single label class for acceptable generalization across sample variation. This kind of off-line processing is unsuitable for a real-time incremental learning system. In contrast, the CCI PCA features used in this invention has the following desirable properties.

Theorem 2 (MHTG): The CCI PCA feature space is MHTG without a need for off-line processing to establish cluster equivalence required by otherwise symbolic labels.

Proof: First, muscles-like: The dimension of PCA is much lower than the original sound space. The CCI PCA feature space is muscles-like, much fewer “muscles” than the required number of “muscle” patterns or the dimension of muscle patterns. This is like fewer clusters than samples in symbolic clustering. Second, high-dimensional: The CCI PCA space is of k-dimensional which can deal with a very high-dimensional raw sound space as long as the raw sound space is from structured nature world (e.g., not random). Third, temporally-dense: The density of PCA frames is as high as frames across time, going beyond any human can process in real-time. Fourth, globally-smooth bi-directionally: Both from sound space z to PCA feature space v and vice versa. To prove mapping from space of z to space of v is smooth, all we need [11] is that the norm of matrix W^{T} is bounded which is true. To prove that from space of v to space of z is smooth, all we need is that the norm of the matrix W is bounded which is also true. Finally, to prove without a need for off-line processing to establish cluster equivalence. This is true because unlike symbols that do not keep the original distance between two different symbols, the distance between any two feature vectors v₁ and v₂, according to the PCA projection equation (Eq. (11)) should be:

∥v₁−v₂∥≈∥x₁−x₂∥

which is best kept by PCA [11] among all possible linear projections of dimension k.

Theorem 2 gives key properties for the motor model developed through CCI PCA to enable fully autonomous learning without a human in the loop. All machine learning methods that use symbolic labels are not fully autonomous because they require a human in the loop of handcrafting labels.

Next, let us discuss our network, DN-2, that learns to produce action sequences from interacting with the environments through sensory frames and self-supervised or teacher-provided motor frames.

### II. Developmental Network 2 (DN-2)

The DN-2 framework has evolved from DN-1. It inherits important characteristics from DN-1, including emergent representations, Lobe Component Analysis (LCA) [32] for neural incremental learning and a general-purpose learning framework. It also has the ETM logic like DN-1. The most fundamental difference between DN-1 and DN-2 is that the latter automatically generates the resources of a hierarchy while a human designs such a resource hierarchy for DN-1. By resources, we mean the number of neurons of each neuronal area, while the total number of neurons could be a constant.

The global structure of DN-2 is similar to that of DN-1, as illustrated in FIG. 3. It has three areas—a sensory input area X which takes sensory inputs; a motor area Z (muscle neurons) which receives supervisions or generates actions; and a hidden area Y which bi-directionally connects with the X and Z areas to learn context-input features. The Y area is “skull-closed”, which means it cannot be accessed after its birth for any direct manipulation by a human programmer. Namely, everything inside the Y area must be fully automatic after birth, so that the network is truly task-independent.

During learning, DN-2 incrementally generates optimal spatiotemporal clustering based on the incre-mental Hebbian learning theory. Specifically, the neurons in Y area have weights to match the partial or all inputs from the X area, Z area and Y area. The neurons in Z area have weights to match the inputs from Y area. All the inputs are from the last frame. The inputs from Y area are the Y area's firing patterns at last frame. In Y and Z areas, the neurons form local inhibition zones. In each local inhibition zone, the local top-k competition mechanism allows k neurons with the best matches of inputs to fire and learn. DN-2 uses Y neurons as clusters to approximate the features in Z×Y×X space. When the neuronal resources are sufficient, DN-2 learns error-free by growing Y neurons with new weights. The newborn Y neuron newly initializes a different cluster that exactly matches the new context-hidden-input feature. When the neuronal resource are limited, the Y neurons are doing optimal tessellation (in the sense of maximum likelihood) in the Z×Y×X space.

### A. New Mechanisms

We modeled several biology-inspired mechanisms in DN-2 to help it to process sensory-motor sequences. These mechanisms are briefly introduced below.

The Y neurons with different connections: Based on the studies about early wirings in the brain [4], Y neurons with different connection patterns are modeled by DN-2 to speed-up the development. We denote these connection patterns using three binary bits as xyz. Each bit represents the connection relationship with X, Y and Z areas: “1” represents with connections, while “0” represents no connections. All the names of these types and their connection relationships are listed in Table II. This is similar to the biological development of connection patterns regulated by genes. Although it is possible for each hidden neuron to develop its own connection patterns using Hebbian learning [32] and synaptic maintenance [27], such connection patterns reduce the time needed in “biological prenatal development”. Computationally, this will help DN-2 to quickly generate reasonable representations in an early learning period.

In our phoneme experiments, type 100 and type 111 Y neurons mainly grow to build different inner representations during the learning procedure.

Local receptive fields and local inhibitions zones: In DN-2, a local receptive field is designed for some types of Y neurons with connections of X area. So that these Y neurons extract different

TABLE II
Y neuron types

| | Type | | | | | | |
|---|---|---|---|---|---|---|---|
| Area | 001 | 010 | 011 | 100 | 101 | 110 | 111 |
| X | No | No | No | Yes | Yes | Yes | Yes |
| Y | No | Yes | Yes | No | No | Yes | Yes |
| Z | Yes | No | Yes | No | Yes | No | Yes |

local features at different locations. The local top-k competition mechanism is designed in DN-2. Each hidden neuron decides which neurons to compete with and therefore, there are no handcrafted boundaries of competition within the hidden Y area. The local top-k competition enables neurons with different connection modes to detect different features.

Let us take type 100 Y neurons as an example. The type 100 Y neurons have the same scale of local receptive fields but focusing on different locations of the input domain. The local top-k competition enables these neurons to only compete with others having receptive fields at similar locations. These mechanisms work together to guarantee the neuronal resources are evenly arranged for the entire sensory regions.

Y to Y connections: In DN-2, some types of Y neurons have lateral connections with other Y neurons to transfer the spatiotemporal information among them. When DN-2 is processing sequences, the responses from the last frame are taken as the inputs for these neuron's lateral connections.

A mechanism of synaptic maintenance [27] is used in the lateral connections to automatically finetune the connection patterns according to the statistics in the learning experience. Growing the potential lateral connections is included in the synaptic maintenance so that DN-2 can discover new statistic dependencies [37]. After synaptic maintenance, the lateral connections among Y neurons record the causal relationships across time series and dynamically build and shape the inner hierarchical structure.

### B. Real Value Sections in Motor Area

In DN-2, there are several handcrafted concept zones in the motor area Z for different learning tasks. Each concept zone represents all the states of that concept. For example, the object type concept zone is designed in the object classification task. This concept zone may contains the states like “dog”, “cat” as the object types. In the Z area, there are also local competition within each concept zone since the neurons in the same concept zone compete with each other to fire.

In this invention, we design the real value sections in the motor area for the MHTG real-valued actions. Each real value section represents the real values in some range. Each firing pattern in the real value section indicates a real value. A firing pattern formed by all real value sections forms a real-valued vector that is suitable for simulating a motor firing pattern of certain dimensionality. This kind of pattern is the key point for driving the muscles of an a robot to perform subtle and flexible natural actions (e.g., speak through a speaker).

In our phoneme experiments below, we used 60 real value sections in the motor area of DN-2 to generate a 60-D real-valued vector at each frame. Each real value section contains 128 Z neurons to indicate a real value in the range from −1 to 1.

C. Work flow of DN-2

At time t, the Y neurons receive the input pair (xₜ₋₁, yₜ₋₁, zₜ₋₁). Each Y neuron computes all the inner-products between its partial weights and corresponding inputs for all connected areas. Then it averages these inner-products as its response. For example, the type 100 Y neuron only computes the inner-product between its weights and sensory input as its response. The Y neurons in the same local inhibition zone compete with their response values to fire. Among each type, if all neurons cannot match the inputs well (a value depending on the growth hormone), a new neuron of the same type grows to learn as neuron splitting (mitosis). The response vector of the hidden area Y at time t is used as input by the motor area Z at time t+1.

At time t+1, the Z neurons fire according to the supervised pattern if the supervision is provided, and link the Y area's firing pattern yₜ at time t. Without supervision, the Z neurons complete to fire and learn based on the match with yₜ. The learning for each winner neuron is an incremental update of its weights and firing age. This procedure is shown in FIG. 3. The Y neurons in the same local inhibition zone compete to fire and learn at each moment. The DN-2 incrementally initializes new Y neurons when the existing Y neurons cannot represent the context-hidden-input sample (x, y, z) well. The green nodes in Y area represent type 111 neurons, which have global receptive fields to the sensory area. While the yellow nodes in Y area represent type 100 neurons, which have local receptive fields. For simplicity, we only show a small part of the type 100 neurons. The neurons with red outlines represent firing neurons. In the Z area, the first column indicates a phoneme class concept zone, while other columns represent the real value sections. The Z neurons in each concept zone or real value section compete to fire. The raw waveform frames are processed into the feature patterns as practiced (heard) sensory inputs. They are also encoded to real value actions as motor supervision. Conversely, the outputs of real value actions can be decoded to waveform frames.

It is demonstrated in [39] that DN-2 can incrementally learn any finite automaton (or equivalently Turing machine) one transition at a time after “birth”. The Y neurons in DN-2 exactly match the current context-input vector (xₜ, zₜ) and then store this pattern in their weights. And after at least two updates, the firing Y neurons form a pattern corresponds to an output state zₜ₊₂: (xₜ, zₜ)→zₜ₊₂. One network update is from X to Y, and the other is from Y to Z.

D. The algorithm of DN-2

We list the outline of the DN-2 algorithm as follows.

Input areas: X and Z. Hidden area: Y. Output areas: Z.
1) For Y area, initialize its adaptive part N_{y} and response vector y. N_{y} includes the synaptic weights and the neuronal ages. Y neurons are initialized with random weights, zero firing age and zero response as the initial state. Later they can transfer to active state. Set the total number of Y neuron to be n_{y}. A boundary c_{y} indicates the number of active neurons (c_{y}≤n_{y}). Z area initializes its adaptive part N_{z} and the response vector z in similar way.
2) At time t=0, supervise initial state z(t=0). Input the first sensory input x(t=0).
3) At time t=1, . . . , repeat the following steps forever (executing steps 3a,3b in parallel, before step 3c):
   a) All Y neurons compute in parallel:

(y(t),N′_{y})=ƒ_{y}(p_{y}(t−1),N_{y}) (4)
where p_{y}(t−1)=(x(t−1), y(t−1), z(t−1)), and ƒ_{y} is the Y area function to be explained below. If active Y neurons' responses are less than a threshold, area Y transfers initial neurons to active state. And update the boundary c_{y}.
   b) Components in z(t) are supervised if they are never fired. Otherwise, Z neurons compute Z area's response vector z(t) and the adaptive part N′_{z} in parallel:

(z(t),N′_{z})=ƒ_{z}(p_{z (t-}1),N_{z}) (5)
where p_{z}(t−1)=y(t−1), and ƒ_{z} is the Z area function to be explained below.
   c) Update asynchronously: N_{y}←N′_{y} and N_{z} ←N′_{z} . Input the sensory input x(t).

The area function ƒ_{y} in Eq.(4) and area function ƒ_{z} in Eq.(5) include 1) the computation of response vectors y(t) and z(t) and 2) the maintenance of adaptive parts N′_{y} and N′_{z} for Y area and Z area, respectively.

### E. Details of the Area Function

1) Initialization: In Y area, there are k+1 active neurons for each type when initialization. Whenever the network takes an input p, all active Y neurons compute the pre-responses. If the pre-response of top-1 winner in a type is lower than the almost perfect match m(t) of this type, an initial neuron of the same type transfers to active state and fires. The almost perfect match m(t) of each type Y neurons changes across time. In Z area, all neurons are set in the active states.

2) Response computation and competition: At time t, the bottom-up part of the pre-response of a active neuron i with bottom-up connection (e.g., type 100, 101, 110 and 111) is calculated using inner-product:

$${r}_{b , i}^{′} ( t ) = \frac{{x}_{i} ( t - 1 )}{‖ {x}_{i} ( t - 1 ) ‖} \cdot \frac{{w}_{b , i}}{‖ {w}_{b , i} ‖} . \qquad ( 6 )$$

where w _{b, i} is the bottom-up part of neuron i's weights. xᵢ(t−1) is the sensory vector in neuron i's receptive field at time t−1. The top-down part of pre-response r′_{t,i}(t) and lateral part of pre-response r′_{l, i} (t) are computed in the same way. The input for r′_{l, i}(t) is Y area's firing pattern y(t−1) from last frame. The input for r′_{t,i}(t) is the motor pattern z(t−1) from last frame. In our phoneme experiments, the motor pattern contains the frame-wise action encoded by CCI PCA and the one-hot vector representing the phoneme type (zero vector for the unsupervised frames).

Each active Y neuron adds all the parts corresponding to the matches with connected areas, and then take the average of these parts as its pre-response. For example, the type 111 neuron i has bottom-up part, lateral part and top-down part, its pre-response r′ᵢ(t) is computed as:

$${r}_{i}^{′} ( t ) = \frac{1}{3} ( {r}_{b , i}^{′} ( t ) + {r}_{t , i}^{′} ( t ) + {r}_{l , i}^{′} ( t ) ) \qquad ( 7 )$$

For type 011, 101 and 110 Y neurons, their pre-responses consist of two parts. For type 001, 010 and 100 neurons, their pre-responses consist of only one part.

To simulate inhibitions, we define local inhibition zones for the Y neurons. Only if this neuron is among top-k winners in its local inhibition zone, it can fire. In this invention, we designed the local zones for type 100 according to the focusing locations of their local receptive fields. For other types of neurons, their local inhibition zones are designed based on their types.

In neuron i's local inhibition zone Yᵢ: ρ(i)=rank max_{j∈Y}_{ᵢ}(r′ⱼ), we rank the top-k+1 pre-responses: r′_{1,i}≥r′_{2,i} . . . ≥r′_{k+1,i}.

If neuron i is among top-k winners, we scale its response value yᵢ(t) in (0, 1]:

$${y}_{i} ( t ) = \frac{{r}_{ρ ( i ) , i ( t )}^{′} - {r}_{k + 1 , i}^{′} ( t )}{{r}_{1 , i}^{′} ( t ) - {r}_{k + 1 , i}^{′} ( t )} . \qquad ( 8 )$$

Otherwise, yᵢ(t)=0. In this way, all Y neurons compute their responses in parallel. The Z area computes its response vector z(t) using above method similarly. Each Z neuron computes the inner-product between its weights and the Y area's response vector y(t−1) as its pre-response. The Z neurons in each concept zone or real value section compete to fire.

3) Hebbian learning: When neuron i fires, its firing age is incremented nᵢ←nᵢ+1 and each component wᵢⱼ of its weight vector wᵢ is updated as:

wᵢⱼ←β₁(n₁)wᵢⱼ+β₂(nᵢ)yᵢ\dot{p}ᵢⱼ(t) (9)

where\dot{p}ᵢⱼ(t) is j-th component of input vector \dot{p}ᵢ(t). β₂(nᵢ) is the learning rate depending on the firing age of this neuron and β₁(nᵢ) is the retention rate, β₁(nᵢ)+β₂(nᵢ)≡1. The Z area updates the adaptive part similarly. The firing Y neurons also update their deviation between weights and inputs for synaptic maintenance.

Synaptic maintenance: After a certain number of firing, the neuron would conduct synaptic maintenance to dynamically fine-tune its receptive fields. Specifically, synaptic maintenance trims the connections where the deviation between weights and inputs is larger than a threshold. Only the stable connections would be kept after synaptic maintenance.

In DN-2, synaptic maintenance is not only cutting unstable synapses but also growing potential synapses. Specifically, each Y neuron (with lateral connection) tracks the other neurons who have most stable connection with it, and grows synapses with the neighbors of these neurons (according to the distances in 3D location space). All the details of synaptic maintenance are in our previous work [37]

### III. Experiments

The experiments in this invention used DN-2 for simultaneous phoneme recognition and synthesis across time series as an example of frame-wise MHTG action generation. In our experiments, the action outputs can be decoded to playable sound frames. We trained DN-2 with only temporally-sparse supervision of phoneme types. We also compared the recognition results of DN-2 and DN-1 with different settings. The code is available on the following page: https://github.com/wux0080/Phoneme-synthesis-and-maze-navigation-based-on-DN-2. Teaching DN-2 to learn this task in a reinforcement learning mode is in our plan for the future.

For the simulated lifetime, we first developed its speaking motor as early lifetime. We explicitly played all the pre-recorded phonemes (time-shifted instead of asking a speaker (Xiang Wu, XW) to pronounce in real-time during machine training) to DN-2, as early hearing lessons. In the early lifetime for motor development, DN-2 heard a speaker pronouncing 20 phonemes with silence in between. It developed its speaking motor using CCI PCA (see FIG. 2 flow (2)) but without speaking at the same time.

Then, we conducted the listening-while-speaking (Test 1 re-substitution in Table III). We used a recorded phoneme sequence of the same speaker XW to enable the DN-2 to listen (see FIG. 2 flow (2)) while speaking through the self-supervised motor. In theory, the first epoch of the entire phoneme sequence is sufficient to reach all-zero errors in the following session of re-substitution test as recognition while self-motor speaking (in its own voice) and producing phoneme labels at the end of every phone. This was indeed true experimentally. How did we make sure that the DN-2 learned individual phonemes instead of a possible word as a concatenation of multiple phonemes? The key is in the supervised concept zone of phoneme class—we supervised the concept to be “silent” from the end of every phoneme—instead of a state that takes the context of the previous phoneme into account.

In later lifetime lessons, we conducted disjoint tests. We played other phoneme sequences recorded at different times from the same speaker XW and then the DN-2 recognized while self-motor speaking with class-label action at the end of every phoneme. These disjoint tests are marked as Tests 2, 3, 4 disjoint in Table III.

In future, if the robot hears continuous phonemes without silence in between and we set the machine free (instead of motor-supervised), its motor will hopefully reach a new state other than motor-supervised here, which could correspond to a new concept of a specific word.

### A. Input Processing and Action Encoding

In this invention, all the training and test sequences contain 20 phonemes and silence among them. To better inspect DN-2's performance, these phonemes are with different characteristics: 5 phonemes are short vowels; 5 long vowels; 5 gliding vowels; 5 short consonants. The recordings of these phonemes are from the audition dataset of the 2016 Artificial Intelligent Machine Learning (AIML) Contest [10].

The phonemes are between 210 ms to 770 ms long. All the phonemes were cut into 20 ms frames with a 10 ms overlap. Between the adjacent phoneme frames, there is 50 ms silence. The entire training and test sequences are around 1800 frames, which were fed to DN-2 for continuous learning. With a sampling rate of 44.1 kHz, each frame has 882 elements.

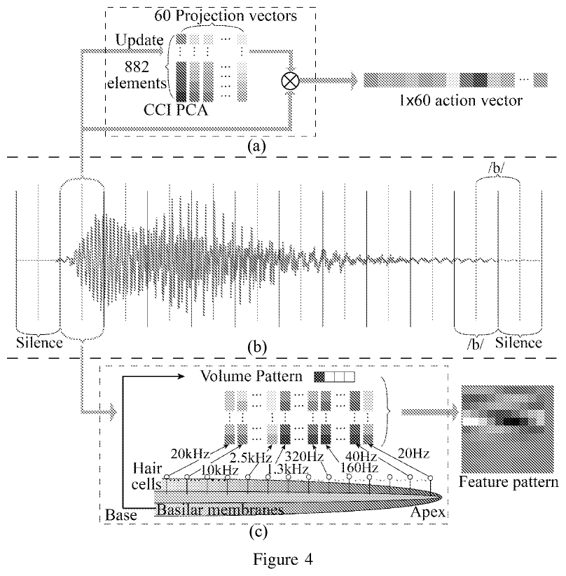

The process of the cochlea was simulated for each raw input frame to generate a feature pattern that represents responses from hair cells in the cochlea (shown in FIG. 4). These hair cells represent band-pass filters each of which corresponds to a different tuned central frequency and phase. In computation, each frame of raw waveform was multiplied with these filters (sine functions) to generate an 11×10 feature matrix. According to the l₂-norm of the feature matrix, a 1×4 volume-level vector was arranged as well. The computational details are in our previous work [36].

If directly synthesize 882 real-valued elements in each data frame, a total of 128×882=112,896 Z neurons are needed in DN-2 to compute their responses in parallel. This is too computationally expensive for DN-2 to perform in real-time. We adopted the CCI PCA algorithm [33] to these data frames to generate lower-dimensional real-valued vectors. CCI PCA is essential for real-time applications since it did not require a batch data. The dimension of 60 was selected in this experiment as a tradeoff between dimensionality reduction and percentage of explained data variance.

Specifically, the CCI PCA incrementally constructed and updated a projection matrix W of dimension 882×60, consisting of 60 projection vectors to map the original input frame of 882-D to a lower 60-D feature space, shown in FIG. 4, where (a) is the procedure of dimensionality reduction using CCI PCA, (b) the labeling example of phoneme /b/ and (c) the model of cochlea processing. In (a), the raw waveform frame was used to update the projection vectors in CCI PCA, and then multiplied the updated projection matrix W (composed of 60 projection vectors) to generate the action (1×60 real value vector). In (b), the labels were sparsely provided during the silence frames and the last two phoneme frames. In (c), the feature pattern was synthesized through multiplying the raw waveform frame with a series of sine functions with different passbands (in different columns) and different initial phases (in different rows) as long as the simple volume pattern.

Later, the transposition of this projection matrix was used in the reconstructions of the waveform frames from each 60-D motor vector produced by the network. We designed 60 real value sections in the motor area to represent the dense self-supervision or emergent frame-wise actions. Each real value section contains 128 Z neurons to approximate a real value in the range from −1 to 1.

We also kept the phoneme class concept zone which consists of silence and 20 phoneme types in Z for recognition. In a phoneme sequence, silence states correspond to silence frames. The phoneme types were provided for the last two frames of the phoneme. The labels of silence were provided for the silence frames between the phoneme sequences. These labels are one-hot vectors which are directly fed to DN-2's motor area. The example of sparse labeling for phoneme /b/ is shown in FIG. 4.

### B. Experimental Configurations for Comparison

To demonstrate the effect of MHTG actions, two configurations—sparse mode and dense mode—were designed for the DN-2 in the experiment. The sparse mode used only phoneme class as supervision, while the dense mode used both phoneme class as supervision and MHTG action as self-supervision. The difference is only about supervision, the hyper parameters are the same in two configurations. The similar two configurations were also designed for DN-1 for comparison.

### C. Training and Test Procedure

In the experiment, we trained DN-2 to learn to pronounce the sounds (phonemes) what it heard. We also taught DN-2 to recognize such sounds. During the experiments, the type 100 and 111 Y neurons in DN-2 mainly grew for leaning. In the beginning, type 100 Y neurons mainly grew and learned volume information and different local features. Then type 111 Y neurons mainly grew to learn different spatial and temporal relations as well as the global feature patterns.

After the training, one re-substitution sequence and three disjoint test sequences were used to measure the performances of recognition. The re-substitution sequence is the same as the training sequence. The three disjoint test sequences are different recordings in the same natural environment when the speaker pronounces again the same phonemes. A person does not pronounce the same phonemes exactly the same twice and the recorded sound waves are different. The recordings are only for time shifts. The re-substitution sequence was also fed into the DN-2 to synthesize the repetition of the audio sequences. During tests, there is no supervision. We should mention that it is important that the self-synthesized actions during the tests also provided the context information for DN-2 to recognize the sound. psl D. Results and Analysis

For recognition, we compared the error rates of the phoneme type concept zone (including the labels of phoneme types and silence), among DN-2 (spare), DN-2 (dense), DN-1 (sparse) and DN-1 (dense) as shown in Table III. The average errors have shown that both DN-1 and DN-2 obtained better performances when self-synthesized actions are available in addition to the sparse class labels at the end of each phoneme sequence. Furthermore, DN-2 made fewer errors since the networks used lateral connections to provide richer spatial and temporal features.

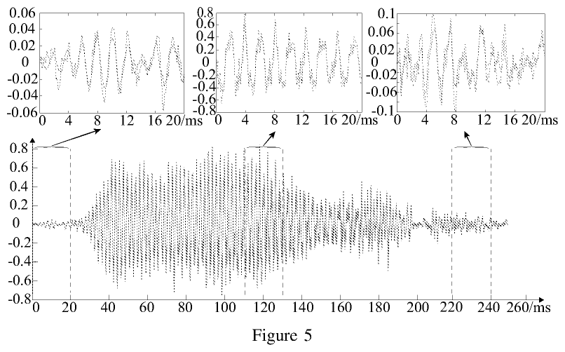

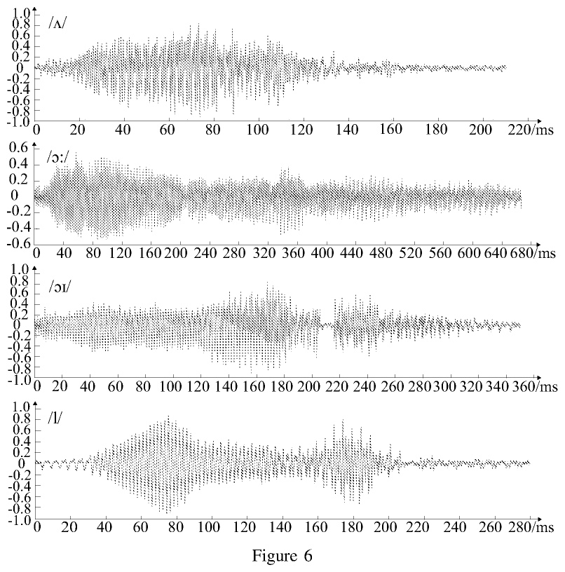

We showed the sounds synthesized by DN-2 in FIG. 5 and FIG. 6. In these two figures, the blue lines represent original waveforms and the red lines represent waveforms synthesized by DN-2.

In FIG. 5, on the upper part, the comparisons of three 20 ms segments are beginning, middle and end part, respectively. We can see clearly that the red waveforms cover the blue ones at most digitally sampled times. This indicates that DN-2 successfully perform the imitation. In FIG. 5, we took phoneme [symbol] as the example to illustrate the comparisons of the beginning, middle and end frames between the

TABLE III
Comparison of Error Rates (%)

| | | | | | | Average of |
|---|---|---|---|---|---|---|
| Methods/Tests | 1 | 2 | 3 | 4 | Average | tests 2-4 |
| DN-1 (sparse) | 2.02 | 27.01 | 26.61 | 25.40 | 20.26 | 26.34 |
| DN-1 (dense) | 0.81 | 11.29 | 9.68 | 10.48 | 8.07 | 10.48 |
| DN-2 (sparse) | 1.21 | 10.48 | 11.29 | 9.27 | 8.06 | 10.35 |
| DN-2 (dense) | 0.0 | 6.45 | 7.26 | 6.85 | 5.14 | 6.85 |

*Test 1: re-substitution; tests 2-4: disjoint tests

original and synthesized sequences. We can see the repetition of the beginning and end frames are not as perfect as the middle one. This is because the waveform amplitude of the beginning and end parts are smaller, and probably they are easier to be disturbed by noise. For voice synthesis, different people have different personal voice. The slight difference between the voice synthesized by DN-2 and the original one could be tolerated as long as we humans can understand what it said.

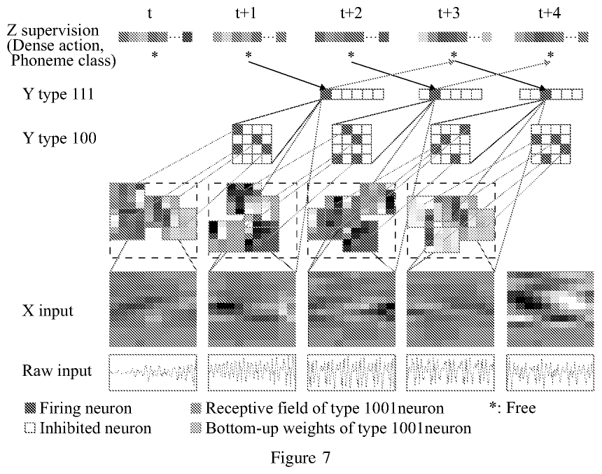

FIG. 7 illustrated how DN-2 chained temporal contexts through lateral connections in the hidden neurons during learning. The type 100 Y neurons detected different local features in the input domain at time t through their bottom-up weights. The type 111 Y neurons connected with both the type 100 Y neurons for time t and the global input domain at time t+1 to form longer temporal contexts (t, t+1) 10 with learned spatial attention and temporal warping.

Specifically, the type 100 Y neurons used their bottom-up weights to extract the local features from different locations of the input domain at time t. The type 111 Y neurons integrated these local features with lateral connection of corresponding type 100 Y neurons. In the meanwhile, these type 111 neurons also took global input domain at time t into their representations. These type 111 and type 100 neurons together built a spatial attention hierarchy and a longer temporal context hierarchy that recursively covers time t+1, time t, and probably earlier time. From the figure, we can see that the type 100 and type 111 Y neurons have different roles during learning.

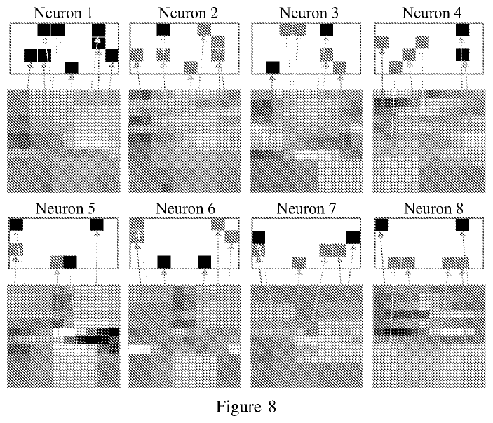

FIG. 8 showed what some of type 111 neurons detect. Note: Each neuron is regulated by its own top-down motor inputs, like telling them what to do. Let us look at eight neurons, from 1 to 8. Each neuron at time t has two maps, upper and lower. Upper: lateral weights for pre-synaptic neurons of type 100 at time t−1. Lower: the set of receptive fields, delayed from frame t−2, for the hair cell map, where a different color shows the receptive field of a different hidden neuron of type 100. These composite receptive fields, through the laterally connected hidden neurons of type 100, have a longer temporal context (t−2 ), spatially selected, spatially warped, and spatially re-combined, all automatically without a need for handcrafting.

Eight hidden neurons of type 111 were randomly chosen from a DN-2 of dense mode setting. The upper part of each subfigure showed as 4×8 images: row major representation. Each pixel in the weight images corresponds to a hidden neuron of type 100; the intensity is the pre-synaptic weight of this type 111 hidden neuron. The lower part of each subfigure showed a 10×11 image in the hair cell response map. The receptive fields of connected type 100 neurons (marked with different colors) were projected into this 10×11 hair cell space to show spatial attention, spatial warping, and spatial recombination. Namely, first, each hidden neuron of type 111 at time t provided a longer temporal context, through time t−1 of type 100 neurons to get input from hair cells at time t−2. Second, using the corresponding lateral weights shown in the corresponding upper part, each hidden neuron of type 111 dynamically selected an aggregate of receptive fields in the hair cells, frequency tuned (e.g., high-pitch vs. low pitch) and spatially attended (i.e., a dynamic set of square receptive fields in the hair cell map from the cochlea).

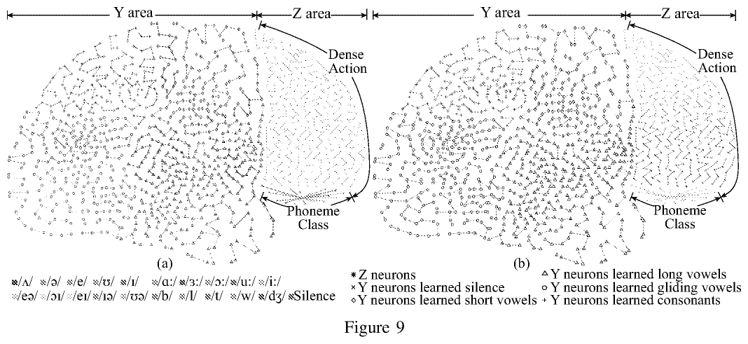

It is desirable that representation in the brain is high dimensional but smooth [9], [14]. FIG. 9 provided a visualization of the embedding of type 111 Y neurons labeled by Z neurons. As we have two concepts in the motor neurons, phoneme type and MHTG actions, FIG. 9 provided motor labels for each. The embedding was shown in the first two components in the PCA of the 3D locations of these hidden neurons, since we can see 2-D visualization clearly. Only the strongest connection of each neuron was illustrated. The case of phoneme types has shown that the neurons learned a specific phoneme were laterally linked across time sequence. The case of MHTG actions has shown that the hidden neurons smoothly transferred in their embedded 2-D space, which supports the smooth property of MHTG.

### E. Tests of Self-Motor by Human Subjects

In the above analysis, the quality of sound synthesis was evaluated through visualization of synthesized sound waves, which is not as direct as being evaluated by human subjects because their classification of self-synthesized sounds is a more practical evaluation method.

We solicited human subjects in the Nanjing University of Science and Technology for evaluation of self-synthesized sounds and got 15 volunteers, 4 females and 11 males (from 24 to 33 years old). They are graduate students. The tests are fulfilled the ethical clearance guidelines on the university of Queensland's website (https://communication-arts.uq.edu.au/ethical-clearance-guidelines).

Subjects were required to play and remember the original sounds of 20 phonemes from XW. Each phoneme waveform was played three times with an interval of 3 seconds in between. Between two different phonemes, there was a 10-second pause during which the human subject wrote down the phonetic symbol corresponding to each phoneme.

For each subject, after the administrator of the experiment (XW) made sure that the subject had reached 100% correct in classification for the re-substitution test, the administrator played all self-synthesized sounds in the same way.

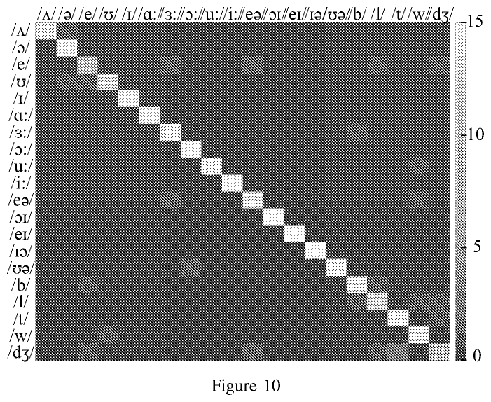

From the record of human-subject reports, we calculated the confusion matrix of the 20 synthesized phonemes whose visualization was shown in FIG. 10. Row: true phoneme classes; columns: subject-reported classes. The value is shown as a pseudo color from 0 to 15 as indicated in the color bar on 10 the right-handed side. Total error rate: 9%, not as good as 5% of DN-2 (dense).

If a non-zero value appears in the off-diagonal area, some errors were made. Indeed most of the self-synthesized sounds sound natural judged subjectively by the volunteers as shown in FIG. 10. Most errors happened in the consonant classification since in general consonants sound more similar than vowels. The total error rate is 27/(20×15)=9%.

Our DN-2 (dense) was also tested for the task for recognition of self-synthesized waveforms in the same way. Specifically, each waveform was fed three times. The result is chosen from the majority output type from the three times. DN-2 (dense) only made a mistake for phoneme /d₃/ So the error rate is 1/20=5%.

Why were humans not as good as our DN-2 (dense) for this phoneme classification task for learner self-synthesized phonemes? This 9% rate is slightly higher than the 5% rate of DN-2 (dense) probably because DN-2 has been trained to do only phoneme classification and synthesis but humans have been trained to do many other challenging tasks. For example, the performance of a human may be affected by how stressful he/she was during the day of phoneme classification task, how well he/she concentrated on the training and test stages, and how well he/she subjectively selected important sound features. The DN-2 network, however, does not have to worry about at least stress and concentration on the task. In this condition, we do not claim that DN-2 did better than humans even for this specific sound recognition task.

### IV. Conclusions and Discussions

This invention is based on a fundamentally different paradigm for machine learning—learning to cognize while learning to speak. This new paradigm is technically made possible by the fact that every DN is optimal [31] statistically in the sense of maximum likelihood at every “post-inception” time instance t, conditioned on its incremental learning, limited computational resources (e.g., the number of neurons), and the limited learning experience up to each time t that should also be a cost of development. Namely, there are no local minima problems associated with traditional neural network learning techniques (e.g., error backprop).

The emergent Turing Machine learned by a DN results in the partition of all sequences of input space into a large number of equivalent classes with different sizes and shapes. This is the first time emergent Turing Machines are modeled as equivalent clusters in the sensorimotor joint space but without doing any batch clustering. As far as we know, this is also the first model about motor development, free from any symbolic labels. We have proved that the automatically developed motor model is MHTG without a need for any batch clustering. As we can see, machine's training schedules seem to be especially critical for further study so as to speed up and consolidate lifetime learning.

The results of comparison experiments show that DN-2 produced meaningful frame-wise actions as temporally-dense self-supervision to synthesize natural sounds. The reduction of the recognition error rate shows that these actions help DN-2 recognize phonemes with only temporally-sparse supervisions. The results also indicated that the motor area can be automatically developed like a vocal tract to approximate temporally-dense labels. It seems possible to enable such a machine to learn while generating temporally-dense labels, with MHTG representations.

This learning-acting-while-sensing invention represents a paradigm shift, toward our goal of Autonomous Programming For General Purposes (APFGP) whose theory has been recently published [28]. We hope that this new paradigm gives better credibility for machines to approach animal-level performance if not yet human-level performance.

### V. Appendices

### A. Declarative Skills and Non-Declarative Skills

The actions we discuss in this invention can correspond to two types of skills—declarative skills and non-declarative skills [24]. Declarative skills can be expressed by a certain natural language (e.g., telling a story). While non-declarative skills are typically not delivered by a natural written language (e.g., bike riding).

During learning, actions carried out by the robot are for both declarative and non-declarative skills. The declarative skills are usually learned in classification or recognition tasks, while the non-declarative skills are often learned in robotic navigation and manipulative tasks. Although we used phonemes synthesis as experimental corpuses in this invention, our theory and simulations on bilingual natural language acquisition [3] have shown that the frame-wise action vectors here have the potential to autonomously develop higher-level or more abstract concepts for longer sequences.

### B. CCI PCA Algorithm

Suppose the input motor sequence is z(t), t=0, 1, 2, . . . In CCI PCA, at each time t, each i-th principal component vector i=1, 2, . . . , k as a unit vector eᵢ(t), updated incrementally up to time t. We construct a corresponding observation vector uᵢ(t), i=1, 2, . . . , k, computed from the raw input z(t) as input for the i-th principal component. However, when t<k, only the first t principal components can 10 be estimated. When t=k, the full k principal components are available for the first time. Whenever possible the first k principal components' vectors are incrementally improved. The CCI PCA algorithm is as follows:

1. Let z̅=z(0). For t=1, 2, 3 . . . do the following steps 2 though 3:

2. Let z̅ be incrementally computed as

$$\overline{z} ← \frac{t - 1}{t} \overline{z} + \frac{1}{t} z ( t ) .$$

Compute the scatter observation u₁=z(t)−z̅.

3. (3.a) If t<k, for i=1, 2, . . . , t−1, update the principal components and their corresponding observation vectors,

$$\{ \begin{matrix}{e}_{i} ← \frac{t - 1}{t} {e}_{i} + \frac{1}{t} [ {u}_{i}^{⊤} \frac{{e}_{i}}{‖ {e}_{i} ‖} ] {u}_{i} \\ {u}_{i + 1} ← {u}_{i} - [ {u}_{i}^{⊤} \frac{{e}_{i}}{‖ {e}_{i} ‖} ] \frac{{e}_{i}}{‖ {e}_{i} ‖}\end{matrix} \qquad ( 10 )$$

and then initialize eₜ=uₜ/∥uₜ∥

(3.b) If t≥k, for i=1, 2, . . . , k only, update using Eq. (10) without initializing eᵢ.

The CCI PCA algorithm incrementally updates its estimations of the principal components along with the learning of DN, and converges to the true top-k PCA vectors quickly. The projection matrix is then W=[e₁, e₂, . . . , eₖ], with W^{T}W=Iₖ, where Iₖ is a k×k identity matrix. The projection generates the self-supervised feature vector:

v(t)=W^{T}(z(t)−z̅ (11)

Weng [30] explained how to incrementally update k so that the variance explained by the first k PCA vectors account for 95% of the total variation.

During test, the network estimates the feature vector v(t) as \hat{v}(t). To reconstruct the sound wave \hat{z}(t) from \hat{v}(t), use the expression:

\hat{z}(t)=z̅(t)+W\hat{v}(t) (12)

### REFERENCES

[1] T. Arai. Education in acoustics using physical models of the human vocal tract. In Proceedings of International Congress on Acoustics, volume 3, pages 1969-1972, Kyoto, Japan, 2004.

[2] A. Bargi, R. Y. D. Xu, and M. Piccardi. Adon HDP-HMM: An adaptive online model for segmentation and classification of sequential data. IEEE Transactions on Neural Networks and Learning Systems, 29(9):3953-3968, 2018.

[3] Juan L Castro-Garcia and Juyang Weng. Emergent multilingual language acquisition using developmental networks. In Proceedings of 2019 International Joint Conference on Neural Networks, pages 1-8, Budapest, Hungary, July 2019. IEEE

[4] Alex Fornito, Andrew Zalesky, and Michael Breakspear. The connectomics of brain disorders. Nature Reviews Neuroscience, 16(3):159-172, 2015.

[5] Dennis Fry. Homo loquens: Man as a talking animal. CUP Archive, Cambridge, United Kingdom, 1977.

[6] Spyros Gidaris, Praveer Singh, and Nikos Komodakis. Unsupervised representation learning by predicting image rotations. arXiv preprint, arXIV: 1803.07728, 2018.

[7] Geoffrey E. Hinton, Alex Krizhevsky, and Sida D. Wang. Transforming auto-encoders. In Proceedings of International Conference on Artificial Neural Networks, pages 44-51, Espoo, Finland, June 2011.

[8] S Hochreiter and J Schmidhuber. Long short-term memory. Neural Computation, 9(8):1735-1780, 1997.

[9] Alexander G Huth, Shinji Nishimoto, An T Vu, and Jack L Gallant. A continuous semantic space describes the representation of thousands of object and action categories across the human brain. Neuron, 76(6):1210-1224, 2012.

[10] Brain-Mind Institute. 2016 artificial intelligence machine learning contest, 2016. http://www.brain-mind-institute.org/AIMLcontest/index-2016.html.

[11] I. T. Jolliffe. Principal Component Analysis. Springer-Verlag, Berlin, 1986.

[12] Ameet Joshi and Juyang Weng. Autonomous mental development in high dimensional context and action spaces. Neural Networks, 16(5-6):701-710, 2003.

[13] Nandakishore Kambhatla and Todd K Leen. Dimension reduction by local principal component analysis. Neural Computation, 9(7):1493-1516, 1997.

[14] Nikolaus Kriegeskorte and Rogier A Kievit. Representational geometry: Integrating cognition, computation, and the brain. Trends in Cognitive Sciences, 17(8):401-412, 2013.

[15] B. Li, Y. Zhang, T. Sainath, Y. Wu, and W. Chan. Bytes are all you need: End-to-end multilingual speech recognition and synthesis with bytes. In Proceedings of IEEE International Conference on Acoustics, Speech and Signal Processing, pages 5621-5625, Brighton, United Kingdom, May 2019.

[16] Jun Liu, Gang Wang, Ping Hu, Ling-Yu Duan, and Alex C. Kot. Global context-aware attention lstm networks for 3D action recognition. In Proceedings of IEEE Conference on Computer Vision and Pattern Recognition, pages 1647-1656, Honolulu, Hi. USA, July 2017.

[17] Nadia Mammone, Cosimo Ieracitano, and Francesco C. Morabito. A deep CNN approach to decode motor preparation of upper limbs from time-frequency maps of EEG signals at source level. Neural Networks, 124:357-372, 2020.

[18] J. C. Martin. Introduction to Languages and the Theory of Computation. McGraw Hill, Boston, Mass., USA, 3rd edition, 2003.

[19] T Mikolov, S Kombrink, L Burget, J Cernocký, and S Khudanpur. Extensions of recurrent neural network language model. In Proceedings of IEEE International Conference on Acoustics, Speech and Signal Processing, pages 5528-5531, Prague, Czech Republic, May 2011.

[20] Cristiano Premebida, Diego R Faria, and Urbano Nunes. Dynamic bayesian network for semantic place classification in mobile robotics. Autonomous Robots, 41 (5):1161-1172, 2017.

[21] Natraj Raman and Stephen J Maybank. Activity recognition using a supervised non-parametric hierarchical hmm. Neurocomputing, 199:163-177, 2016.

[22] Myung-Cheol Roh and Seong-Whan Lee. Human gesture recognition using a simplified dynamic bayesian network. Multimedia Systems, 21(6):557-568, 2015.

[23] M. Schuster and K. K. Paliwal. Bidirectional recurrent neural networks. IEEE Transactions on Signal Processing, 45(11):2673-2681, 1997.

[24] R. Sun, P. Slusarz, and C. Terry. The interaction of the explicit and the implicit in skill learning: A dual-process approach. Psychological Review, 112(1):59-192, 2005.

[25] L?szl? Toth, G?bor Gosztolya, Tam?s Grósz, Alexandra Markó, and Tam?s G?bor Csapó. Multi-task learning of speech recognition is and speech synthesis parameters for ultrasound-based silent speech interfaces. In Proceedings of Conference of the International Speech Communication Association, pages 3172-3176, Hyderabad, India, September 2018.

[26] Pascal Vincent, Hugo Larochelle, Yoshua Bengio, and Pierre Antoine Manzagol. Extracting and composing robust features with denoising autoencoders. In Proceedings of the 25th International Conference on Machine Learning, pages 1096-1103, Helsinki, Finland, June 2008.

[27] Yuekai Wang, Xiaofeng Wu, and Juyang Weng. Synapse maintenance in the where-what networks. In Proceedings of International Joint Conference on Neural Networks, pages 2822-2829, San Jose, Calif., USA, 2011.

[28] J. Weng. Autonomous programming for general purposes: Theory. International Journal of Huamnoid Robotics, 17(4):1-36, August 2020.

[29] J. Weng, J. McClelland, A. Pentland, O. Sporns, I. Stockman, M. Sur, and E. Thelen. Autonomous mental development by robots and animals. Science, 291(5504):599-600, 2001.

[30] Juyang Weng. Natural and Artificial Intelligence: Introduction to Computational Brain-Mind. BMI Press, Okemos, Mich., USA, 2012.

[31] Juyang Weng. Brain as an emergent finite automation: A theory and three theroems. International Journal of Intelligence Science, 5(2):112-131, 2015.

[32] Juyang Weng and Matthew Luciw. Dually optimal neuronal layers: Lobe component analysis. IEEE Transactions on Autonomous Mental Development, 1(1):68-85, 2009.

[33] Juyang Weng, Yilu Zhang, and Wey-Shivan Hwang. Candid covariance-free incremental principal component analysis. IEEE Transactions on Pattern Analysis and Machine Intelligence, 25(8):1034-1040, 2003.

[34] D. J. Wood, J. S. Bruner, and G. Ross. The role of tutoring in problem-solving. Journal of Child Psychology and Psychiatry, pages 89-100, 1976.

[35] X. Wu and J. Weng. Muscle vectors as temporally dense “labels”. In Proceedings of International Joint Conference on Neural Networks, pages 1-8, Glasgow, United Kingdom, July 2020.

[36] Xiang Wu, Yuming Bo, and Juyang Weng. Information-dense actions as contexts. Neurocomputing, 311:164-175, 2018.

[37] Xiang Wu and Juyang Weng. Neuron-wise inhibition zones and auditory experiments. IEEE Transactions on Industrial Electronics, 66(12):9581-9590, 2019.

[38] Zejia Zheng and Juyang Weng. Mobile device based outdoor navigation with on-line learning neural network: A comparison with convolutional neural network. In IEEE Conference on Computer Vision and Pattern Recognition Workshops, pages 11-18, Las Vegas, Nev., USA, June 2016.

[39] Zejia Zheng, Xiang Wu, and Juyang Weng. Emergent neural turing machine and its visual navigation. Neural Networks, 110:116-130, 2019.

What is claimed is:

1. A robot comprising:
at least one sensor coupled to a motor, directly or indirectly, and responding to a physical property within a sensed environment;
at least one effector coupled to a motor controller as a motor area and configured to perform physical manipulation within the sensed environment; and
a computer with a processor and a non-transitory computer-readable memory coupled thereto, wherein the computer is configured to:
implement a robot neural network comprising a plurality of inter-connected neurons organized in said memory to define plural areas, including an X area coupled to communicate data with said at least one sensor, a Z area coupled to communicate data with the said at least one effector, and a Y area to communicate data with the said X area, the said Z area and the Y area itself;
implement an algorithm that updates the robot neural network machine; and
learning of robot sensory recognition and learning of robot motor synthesis take place concurrently on the fly.

2. The robot of claim 1) wherein the motor area uses a Principle Component Analysis (PCA) which gives a representation that is Muscles-like High-dimensional Temporally-dense Globally-smooth (MHTG).

3. The robot of claim 2) wherein the motor area uses a Candid Covariance-free Incremental (CCI) Principal Component Analysis (PCA).

4. The robot of claim 1) wherein the motor area is, at least at some times, free from symbols and is without a human in the loop.

5. The robot of claim 4) wherein the motor area represents declarative skills, non-declarative skills, or a combination thereof.

6. The robot of claim 1) wherein hidden neurons develop hidden features and wherein hidden features correspond to clusters of sensory inputs, state/motor inputs, or a combination thereof, directly or indirectly.

7. The robot of claim 6) wherein the hidden features are components of an emergent Turing machine.

8. The robot of claim 7) wherein the states in the motor area group sequences in the sensory inputs into a finite number of equivalent classes to reach a superior generalization based on a finite automaton as the control of the Turing machine.

9. The robot of claim 8) wherein the motor area is Muscles-like High-dimensional Temporally-dense Globally-smooth (MHTG) without a need for off-line processing to establish cluster equivalence (e.g., without a need for k-mean clustering).

10. The robot of claim 1) wherein at least one hidden neuron has a connection type represented by a 3-bit binary code, xyz.

11. The robot of claim 10) wherein the top-k criterion of competition is based on either a hand-crafted allocation of neurons to hidden areas (like Developmental Network One) or each hidden neuron has its own competition zone (like Developmental Network Two).

12. The robot of claim 1) wherein the firing of hidden neurons are based on competition with other hidden neurons using a top-k criterion on pre-action potentials.

13. The robot of claim 12) wherein the pre-action potentials are based on one or multiple parts of bottom-up, lateral and top-down inputs and wherein each part is a match between the input and the corresponding part of the neuronal weight vector.

14. The robot of claim 1) wherein neuronal learning uses a Hebbian mechanism and wherein random weights of neurons only affect which neurons become active-state neurons but do not affect the resulting robot neural network.

15. The robot of claim 14) wherein the Hebbian mechanism depending on a neuron-specific firing age.

16. The robot of claim 15) wherein the learning rate and the retention rate of each neuron always sum to one and both are dependent on neuron-specific firing age and therefore training one robot network is sufficient for each set of robot tasks because the said robot network is optimal in the sense of maximum likelihood given the Three Learning Conditions (3LC).

17. The robot of claim 1) wherein at least one neuron uses synaptic maintenance to grow or cut its field of inputs.

18. The robot of claim 1) wherein the sensors sense the effects of a developing motor, directly or indirectly, so that the sensed signal is affected by, and the robot learns from, the developing motor.

19. A robot wherein the experiences of that a human synthesizes signals and that the robot synthesizes signals are integrated into a robot neural network memory as neuronal weights so that the robot perceives the similarity and the difference between a human synthesized signal and its own synthesized signal without a need for a human programmer to handcraft and conduct two different training stages—human synthesis and robot synthesis.

20. A robot wherein there is a motor area wherein the motor area has multiple real-value sections wherein each neuron represents a quantized value of the corresponding real value of the section and wherein within-section top-1 competition results in a unique quantized value for the real value.
